(19) United States
(12) Patent Application Publication
(10) Pub. No.: US 2008/0316599 A1
(43) Pub. Date: Dec. 25, 2008

(54) Reflection-Repressed Wire-Grid Polarizer

(76) Inventors: Bin Wang, Orem, UT (US); Eric Gardner, Eagle Mountain, UT (US); Raymond T. Perkins, Orem, UT (US)

Correspondence Address: THORPE NORTH & WESTERN, LLP., P.O. Box 1219, SANDY, UT, 84091-1219, US

(21) Appl. No.: 11/767,336

(22) Filed: Jun. 22, 2007

(51) Int. Cl. G02B 5/30

(52) U.S. Cl. 359/486; 359/483

(57) ABSTRACT

A reflection repressed wire-grid polarizer device for polarizing incident visible or infrared light and selectively repressing a reflected polarization includes at least three layers disposed on a substrate. A polarizing wire-grid layer has an array of parallel metal wires with a period less than half the wavelength of the incident light. A reflection-repressing layer or grid includes an inorganic and non-dielectric material which is optically absorptive of visible or infrared light. A dielectric layer or grid includes an inorganic and dielectric material.

### RELATED APPLICATIONS

This is related to U.S. patent application Ser. No. ______, filed Jun. 22, 2007, as TNW Docket No. 00546-23945.CIP entitled “Selectively Absorptive Multilayer Wire-Grid Polarizer”; and U.S. patent application Ser. No. 11,005,927, filed Dec. 6, 2004; which are herein incorporated by reference.

### BACKGROUND

1. Field of the Invention

The present invention relates generally to an inorganic wire-grid polarizer which has been configured to substantially repress the reflected polarization while substantially transmitting the orthogonal polarization with particular focus on the use of such a polarizer for use in the visible and infra-red portion of the electromagnetic spectrum.

2. Related Art

Various types of polarizers or polarizing beam splitters (PBS) have been developed for polarizing light, or separating orthogonal polarization orientations of light. A MacNeille PBS is based upon achieving Brewster's angle behavior at the thin film interface along the diagonal of the high refractive index cube in which it is constructed. Such MacNeille PBSs generate no astigmatism, but have a narrow acceptance angle, and have significant cost and weight. Such devices can be fabricated to function from the infra-red through the visible to the ultra-violet by appropriate choices of glasses and thin-films.

Many other types of polarizers are also commonly available for the visible and infra-red portions of the spectrum, including long-chain polymer polarizers, wire-grid polarizers, Glan Thompson crystal polarizers, etc. Some of these polarizers separate light into two orthogonal polarizations by reflection, others separate light by absorption. Examples of the former include crystal polarizers such as the Glan Thompson type and Wollaston Prism type, wire-grid polarizers, the MacNeille prism type, and certain polymer reflective polarizers such as the DBEF polarizer manufactured by 3M. Of the later, absorptive type, examples include long-chain polymer “iodine-type” polarizers, K-sheet and H-sheet-type polarizers originally developed by Polaroid, and numerous other types that find uses in flat-panel liquid crystal displays, etc.

Generally, the absorptive-type polarizer has been based on organic molecules such as polymers. A notable exception is the Polarcor type originally developed by Corning and similar products such as those offered by Codixx of Germany. Polarizers of this type have found numerous uses in the infra-red spectrum, where they excel in contrast ratio and transmission efficiency, but only over a fairly narrow wavelength band, which band can be shifted to the desired wavelength by appropriate changes in the manufacturing process. However, this type of polarizer has not successfully been extended into the green and blue portions of the visible spectrum, leaving the visible spectrum poorly served by this technology.

This leaves open a need for an inorganic polarizer which does not have a substantial or strong reflection of one polarization for certain applications in the visible spectrum. An example of these applications exists in the projection display market, in which small, transmissive liquid-crystal display panels are used to create projected images on a screen. Because of the optical design of such systems, it is difficult for them to use reflective polarizers in the image-bearing part of the optical path. There are at least two known reasons for this difficulty. The first is that light reflected back into the display panels is known to cause the transistors in the drive circuitry on the panel to be inoperable due to the photoelectric effect disturbing the transistors operation. The second problem is that the reflected light can cause ghost images and cause a loss of contrast in the image on the screen.

Historically, manufacturers of such projection displays have used polymer-based absorptive polarizers in such projection displays. Over time, as these displays have become brighter, such polarizers have become a weak point in the system, leading to concerns about early failure of the polarizers. To counter this problem, exotic, heat conductive substrate materials such as sapphire have been used, forced-air cooling systems have been employed, and more exotic designs have even used several polarizers in series such that failure of the first polarizer would be masked by the succeeding polarizers in order to obtain an acceptable system lifetime. Continued progress in the display market towards brighter and less-expensive displays means that the time will soon come that such solutions will no longer be practical. Therefore, it is expected that these projection-display systems will need a new solution.

### SUMMARY OF THE INVENTION

It has been recognized that it would be advantageous to develop an inorganic polarizer that has a substantially repressed reflection while still providing substantial transmission of the orthogonal polarization; that has a contrast in transmission greater than about 500:1 in each of the three primary colors of blue, green, and red; that has a reasonable acceptance angle and functions at normal incidence; and that can be made in a plate format. In addition, it would be advantageous if such a polarizer could be manufactured at a reasonable cost to enable its application in the very competitive display market.

The present invention provides a reflection repressed, wire-grid polarizer device for polarizing incident visible or infrared light and selectively repressing a reflected polarization. A polarizing wire-grid layer is disposed over a substrate and has an array of parallel metal wires with a period less than half the wavelength of the incident light. A reflection-repressing layer is disposed over the substrate and includes an inorganic and non-dielectric material which is optically absorptive of visible or infrared light. A dielectric layer is disposed between the polarizing wire-grid layer and the absorptive layer and includes an inorganic and dielectric material.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1a is a cross-sectional schematic side view of a reflection repressed, wire-grid polarizer device in accordance with an embodiment of the present invention;

FIG. 1b is a cross-sectional schematic side view of another reflection repressed, wire-grid polarizer device in accordance with an embodiment of the present invention;

FIG. 1c is a cross-sectional schematic side view of another reflection repressed, wire-grid polarizer device in accordance with an embodiment of the present invention;

FIG. 1d is a cross-sectional schematic side view of another reflection repressed, wire-grid polarizer device in accordance with an embodiment of the present invention;

FIG. 1e is a cross-sectional schematic side view of another reflection repressed, wire-grid polarizer device in accordance with an embodiment of the present invention;

FIG. 2a is a cross-sectional schematic side view of a first exemplary reflection repressed, wire-grid polarizer device in accordance with an embodiment of the present invention;

FIG. 2b is a graph of calculated performance of the polarizer device of FIG. 2a showing the ratio of transmission of p-polarization orientation, total reflection and contrast with respect to wavelength;

FIG. 3a is a cross-sectional schematic side view of a second exemplary reflection repressed, wire-grid polarizer device in accordance with an embodiment of the present invention;

FIG. 3b is a graph of calculated performance of the polarizer device of FIG. 3a showing the ratio of transmission of p-polarization orientation, total reflection and contrast with respect to wavelength;

FIG. 4a is a cross-sectional schematic side view of a third exemplary reflection repressed, wire-grid polarizer device in accordance with an embodiment of the present invention;

FIG. 4b is a graph of calculated performance of the polarizer device of FIG. 4a showing the ratio of transmission of p-polarization orientation, total reflection and contrast with respect to wavelength;

FIG. 5a is a cross-sectional schematic side view of a fourth exemplary reflection repressed, wire-grid polarizer device in accordance with an embodiment of the present invention;

FIG. 5b is a graph of calculated performance of the polarizer device of FIG. 5a showing the ratio of transmission of p-polarization orientation, total reflection and contrast with respect to wavelength;

FIG. 6a is a cross-sectional schematic side view of a fifth exemplary reflection repressed, wire-grid polarizer device in accordance with an embodiment of the present invention;

FIG. 6b is a graph of calculated performance of the polarizer device of FIG. 6a showing the ratio of transmission of p-polarization orientation, total reflection and contrast with respect to wavelength;

Various features in the figures have been exaggerated for clarity. It should also be noted that the features in the Figures are not to scale.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

Definitions.

The term dielectric is used herein to mean non-metallic optical materials, typically consisting of metal oxides, or metal nitrides, metal fluorides, or other similar materials.

The term carbon is used herein to mean carbon in any of its many forms, such as graphite, glassy carbon, amorphous carbon, etc.

The term non-dielectric is used herein to mean metallic optical materials, including carbon and silicon.

Description

It has been recognized that wire-grid polarizers can provide enhanced performance or contrast to projection display systems, such as rear projection display systems. In addition, it has been recognized that the conductive wires of a wire-grid polarizer can absorb light and can heat-up. Furthermore, it has been recognized that multi-layer stretched film polarizers are not durable and reliable in many applications due to their absorption of light, thought such a performance characteristic is desirable.

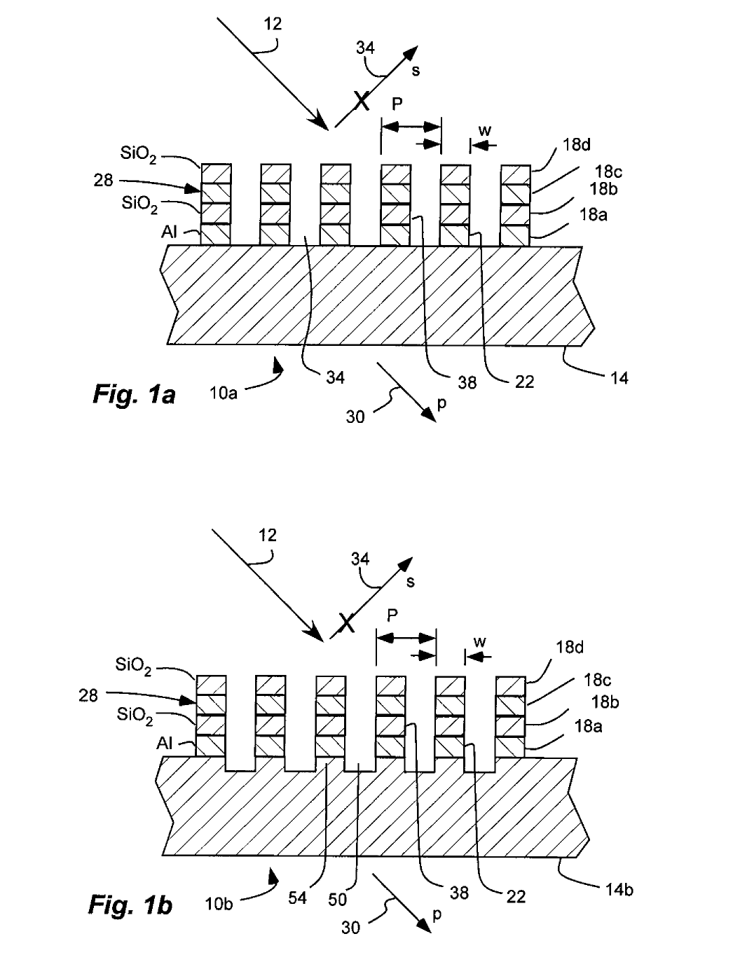

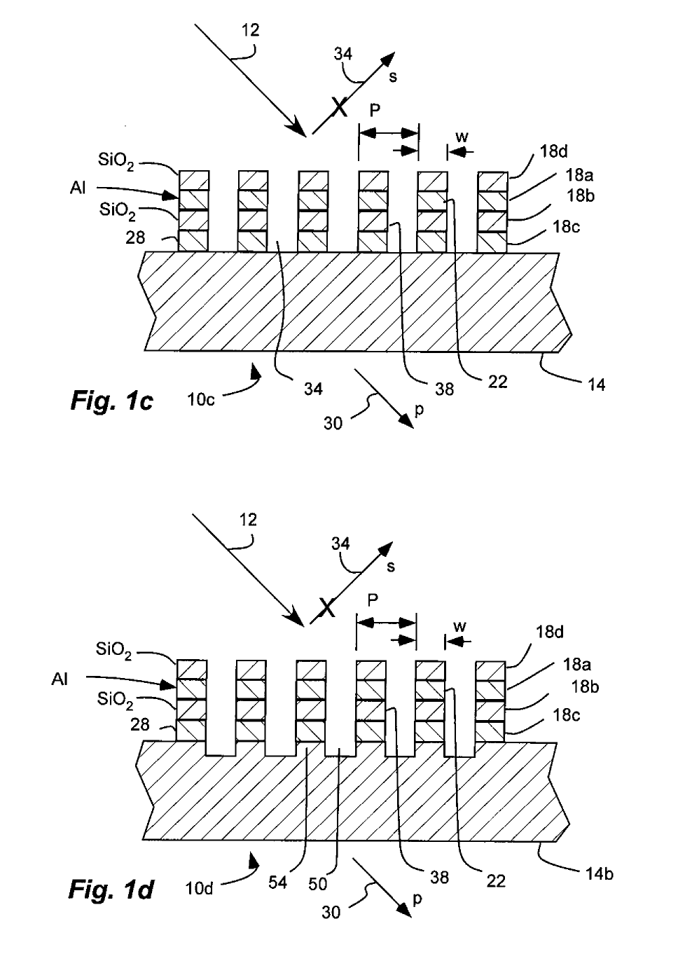

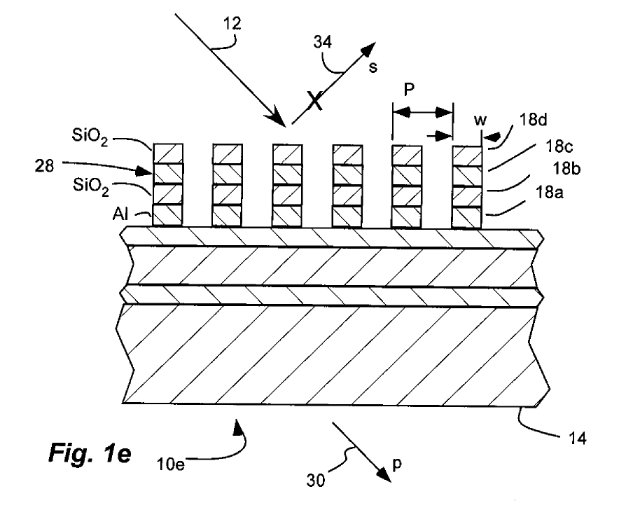

As illustrated in FIGS. 1a-1e, inorganic, reflection repressed, wire-grid polarizers, indicated generally at 10a-e, are shown in an exemplary implementation in accordance with the present invention for polarizing incident visible or infrared light 12, transmitting one polarization 30 (such as p-polarization orientation) and selectively repressing (indicated by X) a reflected polarization 34 (such as s-polarization orientation). The polarizer 10 can include a stack of film layers 18a-d disposed over and carried by a substrate 14. The substrate 14 can be formed of an inorganic and dielectric material, such as BK7 glass or fused silica. In addition, the film layers, and thus the stack, can be formed of inorganic materials. The stack of film layers of the wire-grid polarizers can include at least three layers, including a polarizing layer 18a, a reflection-repressing layer 18c, and a dielectric layer 18b separating the polarizing and reflection-repressing layers. In addition, a fourth layer, or second dielectric layer 18d can be separated from the first dielectric layer 18b by one of the polarizing or reflection-repressing layers. Furthermore, one or more of the layers can be discontinuous to form a form-birefringent layer.

The polarizing layer 18a is a polarizing wire-grid and includes an array of parallel metal wires 22 with a period P less than half the wavelength of the incident light 12. The wires are formed of a conductive material. In one aspect, the wires can be formed of aluminum AL, as shown in FIGS. 1a-c. In another aspect, the wires can be formed of silver. For visible light applications, or when visible light is incident on the polarizer, the period P of the array of wires 22 of the wire-grid is less than 350 nm. In another aspect, the period can be less than 200 nm for visible light applications. In another aspect, the period can be less than 120 nm for visible light applications. It has been found that reducing the period results in increased performance. For infrared applications, or when infrared light is incident on the polarizer, the period P of the array of wires 22 of the wire-grid is less than 500 nm. In addition, the wires are longer than the wavelength of incident light. The wires can also have a width w in the range of 10 to 90% of the pitch or period. The wires can also have a thickness or a height less than the wavelength of the light, or less than 400 nm (0.4 μm) for visible light applications. In one aspect, the thickness can be less than 0.2 μm for visible light applications.

The dielectric layer(s) 18b(d) can be dielectric grid(s) and can include an inorganic and dielectric material. The dielectric material can be optically transmissive in at least the visible or infrared spectral region for visible or infrared applications, respectively. In one aspect, the dielectric material of the dielectric layer can be silicon dioxide (SiO2). The dielectric layer(s) can be discontinuous to form a form-birefringent layer or dielectric grid 36 with an array of parallel ribs 38 separated by gaps. The ribs 38 of the dielectric layer can have the same period as the wires of the wire-grid and can be aligned with the wires of the wire-grid. In addition, one or more of the dielectric layer(s) can be disposed adjacent to the polarizing layer.

The reflection-repressing layer 18c includes an inorganic and non-dielectric material that is optically absorptive of visible or infrared light. In one aspect, the optically absorptive material can be carbon or silicon, or a metal different than the metal of the wires of the wire-grid. Thus, the light incident on the device is divided into two polarizations, one of which is largely absorbed (for example the s-polarization orientation) with some energy reflected, and the other of which is largely transmitted (for example the p-polarization orientation), with some small amount of energy absorbed. In addition, the reflection-repressing layer can be discontinuous to form a reflection-repressing grid with an array of parallel ribs 28.

Thus, an incident visible or infrared light beam 12 incident on the polarizer 10a-d separates the light into two orthogonal polarization orientations, with light having s-polarization orientation (polarization orientation oriented parallel to the length of the ribs) being mostly absorbed with some energy reflected, and light having p-polarization orientation (polarization orientation oriented perpendicular to the length of the ribs) being largely transmitted or passed with a small amount of energy absorbed. (It is of course understood that the separation or these two polarizations, may not be perfect and that there may be losses or amounts of undesired polarization orientation either reflected and/or transmitted.) In addition, it will be noted that the array or grid of ribs with a pitch less than about half the wavelength of light does not act like a diffraction grating (which has a pitch larger than about half the wavelength of light). Thus, the grid polarizer avoids diffraction. Furthermore, it is believed that such periods also avoid resonant effects or anomalies.

Referring to FIG. 1a, the inorganic, reflection repressed, wire-grid polarizer 10a is configured with the reflection-repressing layer 18c disposed over the polarizing wire-grid layer 18a. The first dielectric layer 18b separating the polarizing and reflection-repressing layers. The second dielectric layer 18d is disposed over the reflection-repressing layer 18c.

All the layers 18a-d are discontinuous. The device can be fabricated by depositing the various layers and etching the layers to form the wires and ribs. The dielectric ribs 38 of the dielectric grid, the non-dielectric ribs 28 of the reflection-repressing grid, and the wires 22 of the wire-grid are aligned and have the same period.

Referring to FIG. 1b, the inorganic, reflection repressed, wire-grid polarizer 10b is similar to that described above, but includes a plurality of ribs 54 formed in the substrate 14b and supporting the wires and ribs of the layers thereon. The ribs can be formed by over-etching troughs 50 into the substrate. The ribs can form another dielectric layer between the substrate and the wires.

Referring to FIG. 1c, the inorganic, reflection repressed, wire-grid polarizer 10b is similar to that described above in FIG. 1a, but with the stack of layers inverted so that the polarizing wire-grid layer 18a is disposed over the reflection-repressing layer 18c.

Referring to FIG. 1d, the inorganic, reflection repressed, wire-grid polarizer 10b is similar to that described above in FIG. 1b, but with the stack of layers inverted so that the polarizing wire-grid layer 18a is disposed over the reflection-repressing layer 18c.

Referring to FIG. 1e, the inorganic, reflection repressed, wire-grid polarizer 10b is similar to that described above in FIG. 1a, but further includes one or more continuous layers disposed between the substrate and the wires of the wire-grid to form an anti-reflection coating or to accomplish other optical purposes.

In addition, the thickness of each layer can be tailored to optimize the optical performance (transmission efficiency and contrast ratio) for the desired spectral range.

Therefore, while the thicknesses shown in the figures are the same, it will be appreciated that they can be different. While the stack is shown with four film layers 18a-d, it will be appreciated that the number of film layers in the stack can vary.

As shown in FIGS. 1a-d, all of the film layers are discontinuous and form the arrays of parallel ribs or wires. The ribs or wires can be separated by intervening grooves 34 or troughs. In this case, the grooves 34 extend through the film layers 18a-d to the substrate 14, or even into the substrate. As discussed below, such a configuration can facilitate manufacture.

The grooves 34 can be unfilled, or filed with air (n=1). Alternatively, the grooves 34 can be filled with a material that is optically transmissive with respect to the incident light.

It is believed that the birefringent characteristic of the film layers, and the different refractive indices of adjacent film layers, causes the grid polarizers to substantially separate polarization orientations of incident light, substantially absorbing and reflecting light of s-polarization orientation, and substantially transmitting or passing light of p-polarization orientation with a small amount of absorption. In addition, it is believed that the number of film layers, thickness of the film layers, and refractive indices of the film layers can be adjusted to vary the performance characteristics of the grid polarizer so long as at least one of the layers is strongly absorptive to the incident UV light.

A method of fabricating the polarizers 10a-d includes obtaining or providing a substrate 14. As described above, the substrate 14 can be BK7 glass or fused silica glass. In all aspects, the substrate would be chosen to be transparent to the desired wavelength of electromagnetic radiation. The substrate may be cleaned and otherwise prepared. The layers are formed continuously over the substrate. The layers can be formed by deposition, chemical vapor deposition, spin coating, etc., as is known in the art. The continuous layers are patterned to create discontinuous layers with an array of parallel ribs or wires and defining at least one form birefringent layer. In addition, all the continuous layers can be patterned to create all discontinuous layers. The layers can be patterned by etching, etc., as is known in the art.

### EXAMPLE 1

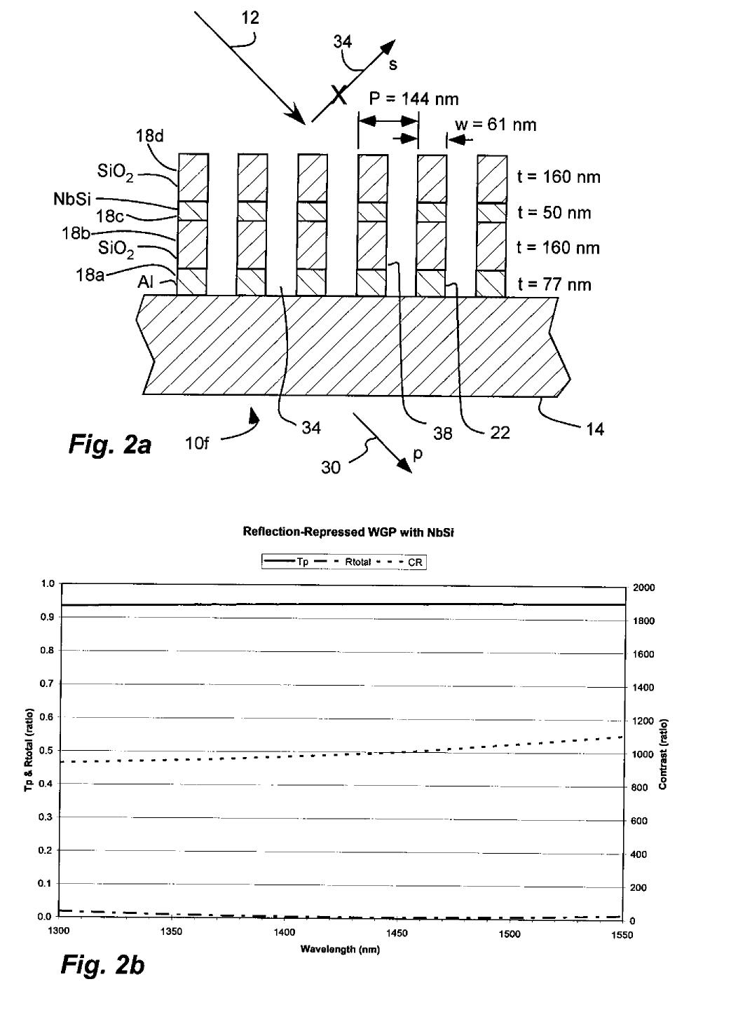

Referring to FIG. 2a, a first non-limiting example of a reflection repressed, wire-grid polarizer 10f is shown configured for use in the infrared spectrum.

The polarizer 10f has four layers disposed over a substrate 14 including a polarizing layer 18a, a reflection-repressing layer 18c, a dielectric layer 18b separating the polarizing and reflection-repressing layers, and a second dielectric layer 18d separated from the first dielectric layer 18b by the reflection-repressing layer. The substrate is glass, such as BK7 glass. The first layer or polarizing layer 18a is disposed on the substrate. The polarizing layer 18a is an array of parallel metal wires 22 formed of aluminum (AL) with a period P of 144 nm. The polarizing layer 18a has a thickness of 77 nm. The reflection-repressing layer 18c is formed of niobium siliside (NbSi; n≈3.8, k≈2.90 at 1550 nm) and has a thickness of 50 nm. The first and second dielectric layers 18b and 18d are formed of silicon dioxide (SiO2) and each have a thickness of 160 nm. All of the layers are discontinuous to form form-birefringent layers. The period P is 144 nm with a duty cycle (DC) or ratio of rib width to period of 0.425, or the width is approximately 61 nm. The niobium siliside material has been chosen because of its optical index and its optically absorptive properties for the incident light. The polarizer will transmit the p-polarization orientation of the light without reflecting either polarization orientation.

Referring to FIG. 2b, the calculated performance of the polarizer 10f is shown in the infrared spectrum. It can be seen that the polarizer has high transmission (approximately 95%) for p-polarization orientation of the light, with substantially no reflection. In addition, the polarizer has a contrast ratio of approximately 1000.

### EXAMPLE 2

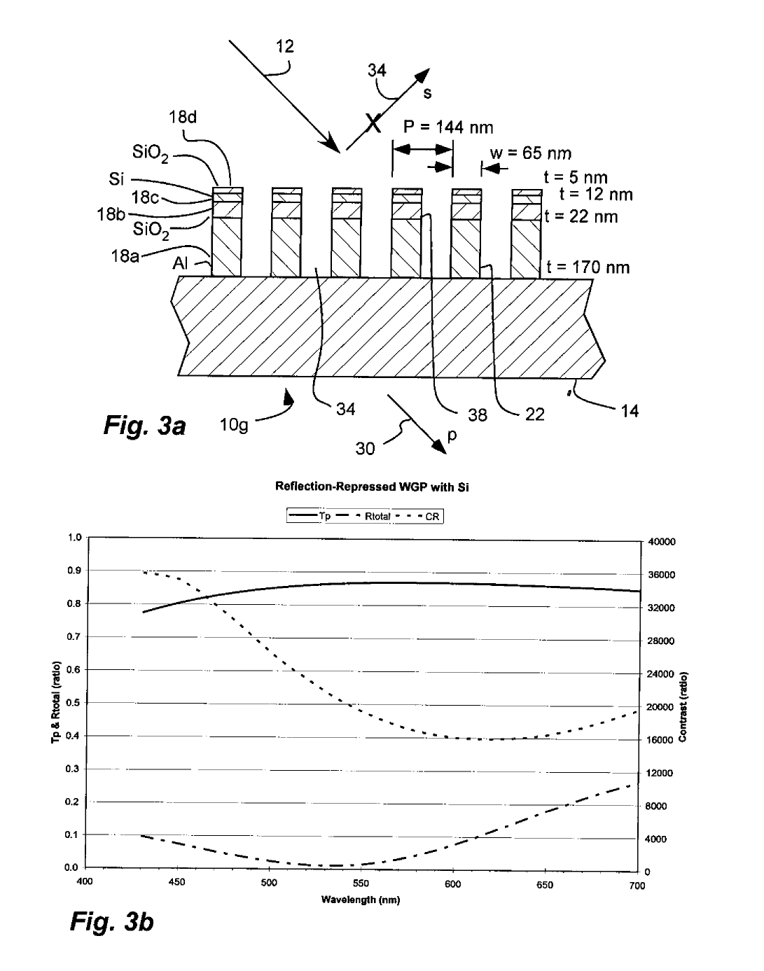

Referring to FIG. 3a, a second non-limiting example of a reflection repressed, wire-grid polarizer 10g is shown configured for use in the visible spectrum.

The polarizer 10g has four layers disposed over a substrate 14 including a polarizing layer 18a, a reflection-repressing layer 18c, a dielectric layer 18b separating the polarizing and reflection-repressing layers, and a second dielectric layer 18d separated from the first dielectric layer 18b by the reflection-repressing layer. The substrate is glass, such as BK7 glass. The first layer or polarizing layer 18a is disposed on the substrate. The polarizing layer 18a is an array of parallel metal wires 22 formed of aluminum (AL) with a period P of 144 nm. The polarizing layer 18a has a thickness of 170 nm. The reflection-repressing layer 18c is formed of silicon (Si; n≈4.85, k≈0.8632 at 550 nm) and has a thickness of 12 nm. The first and second dielectric layers 18b and 18d are formed of silicon dioxide (SiO2) and have a thickness of 22 nm and 5 nm respectively. All of the layers are discontinuous to form form-birefringent layers. The period P is 144 nm with a duty cycle (DC) or ratio of rib width to period of 0.45, or the width is approximately 67 nm. The silicon material has been chosen because of its optical index and its optically absorptive properties for the incident light. The polarizer will transmit the p-polarization orientation of the light without reflecting either polarization orientation.

Referring to FIG. 3b, the calculated performance of the polarizer 10g is shown in the visible spectrum. It can be seen that the polarizer has high transmission (approximately 80%) for p-polarization orientation of the light, with little reflection. In addition, the polarizer has a contrast ratio greater than 16,000 across the visible spectrum.

### EXAMPLE 3

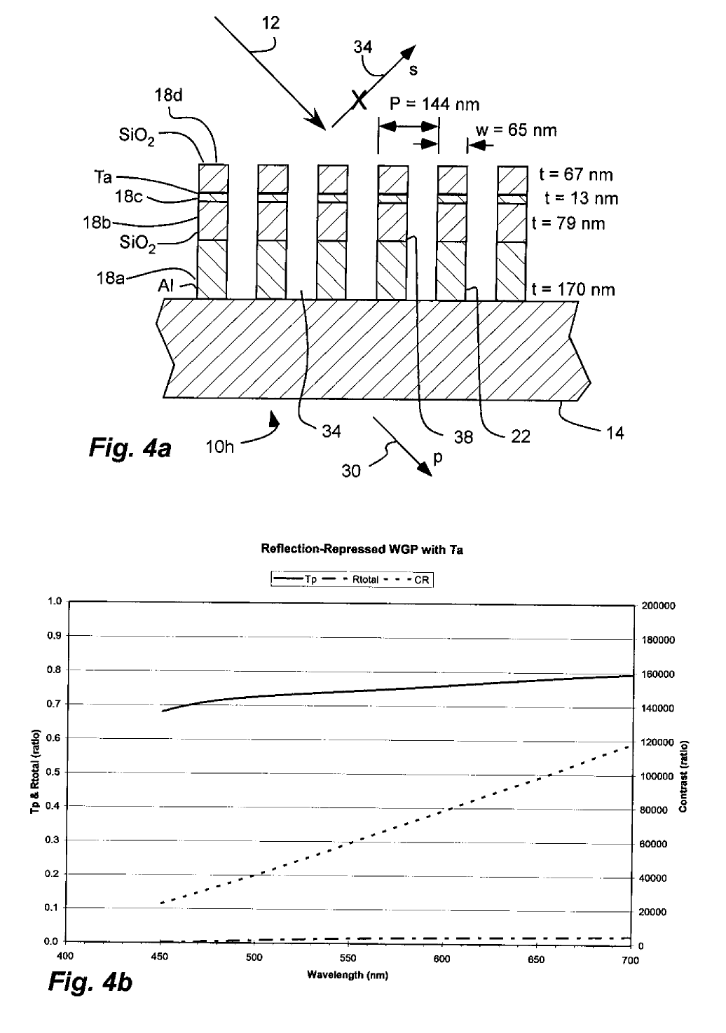

Referring to FIG. 4a, a third non-limiting example of a reflection repressed, wire-grid polarizer 10h is shown configured for use in the visible spectrum.

The polarizer 10b has four layers disposed over a substrate 14 including a polarizing layer 18a, a reflection-repressing layer 18c, a dielectric layer 18b separating the polarizing and reflection-repressing layers, and a second dielectric layer 18d separated from the first dielectric layer 18b by the reflection-repressing layer. The substrate is glass, such as BK7 glass. The first layer or polarizing layer 18a is disposed on the substrate. The polarizing layer 18a is an array of parallel metal wires 22 formed of aluminum (AL) with a period P of 144 nm. The polarizing layer 18a has a thickness of 170 nm. The reflection-repressing layer 18c is formed of tantalum (Ta; n≈2.95, k≈3.52 at 550 nm) and has a thickness of 13 nm. The first and second dielectric layers 18b and 18d are formed of silicon dioxide (SiO2) and have a thickness of 79 nm and 67 nm respectively. All of the layers are discontinuous to form form-birefringent layers. The period P is 144 nm with a duty cycle (DC) or ratio of rib width to period of 0.45, or the width is approximately 67 nm. The tantalum material has been chosen because of its optical index and its optically absorptive properties for the incident light. The polarizer will transmit the p-polarization orientation of the light without reflecting either polarization orientation.

Referring to FIG. 4b, the calculated performance of the polarizer 10h is shown in the visible spectrum. It can be seen that the polarizer has high transmission (approximately 70%) for p-polarization orientation of the light, with substantially no reflection. In addition, the polarizer has a contrast ratio greater than 20,000 across the visible spectrum.

### EXAMPLE 4

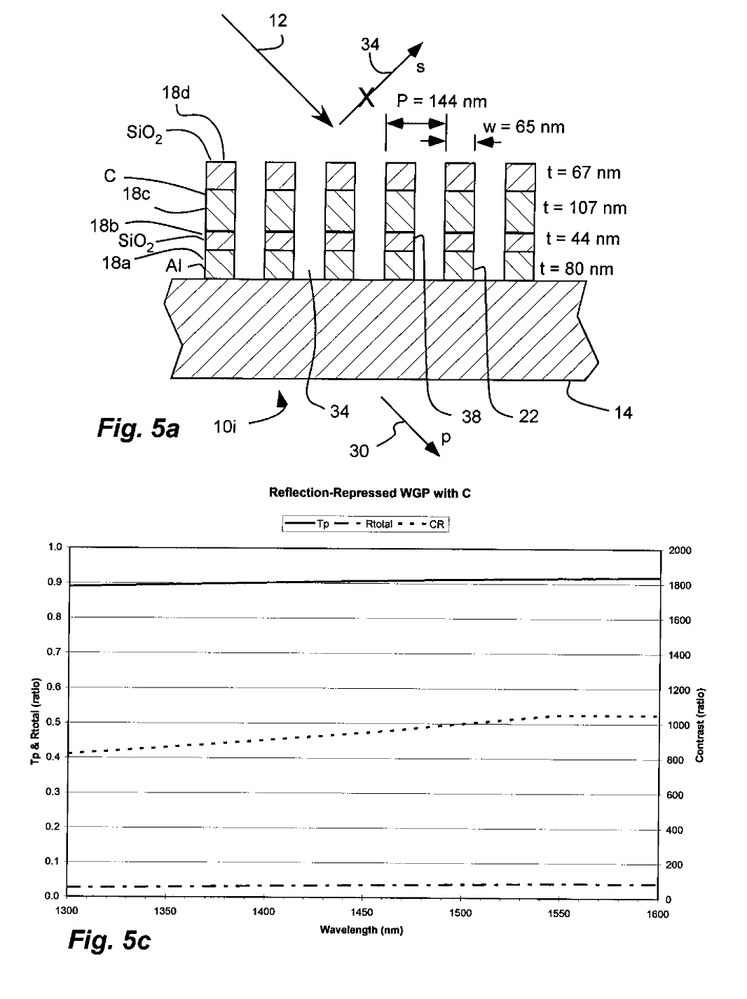

Referring to FIG. 5a, a fourth non-limiting example of a reflection repressed, wire-grid polarizer 10i is shown configured for use in the infrared spectrum.

The polarizer 10i has four layers disposed over a substrate 14 including a polarizing layer 18a, a reflection-repressing layer 18c, a dielectric layer 18b separating the polarizing and reflection-repressing layers, and a second dielectric layer 18d separated from the first dielectric layer 18b by the reflection-repressing layer. The substrate is glass, such as BK7 glass. The first layer or polarizing layer 18a is disposed on the substrate. The polarizing layer 18a is an array of parallel metal wires 22 formed of aluminum (AL) with a period P of 144 nm. The polarizing layer 18a has a thickness of 80 nm. The reflection-repressing layer 18c is formed of carbon (C; n≈3.34, k≈1.6299 at 1550 nm) and has a thickness of 107 nm. The first and second dielectric layers 18b and 18d are formed of silicon dioxide (SiO2) and have a thickness of 44 nm and 67 nm respectively. All of the layers are discontinuous to form form-birefringent layers. The period P is 144 nm with a duty cycle (DC) or ratio of rib width to period of 0.45, or the width is approximately 67 nm. The carbon material has been chosen because of its optical index and its optically absorptive properties for the incident light. The polarizer will transmit the p-polarization orientation of the light without reflecting either polarization orientation.

Referring to FIG. 5b, the calculated performance of the polarizer 10i is shown in the infrared spectrum. It can be seen that the polarizer has high transmission (approximately 90%) for p-polarization orientation of the light, with little reflection. In addition, the polarizer has a contrast ratio greater than 800 across the infrared spectrum.

### EXAMPLE 5

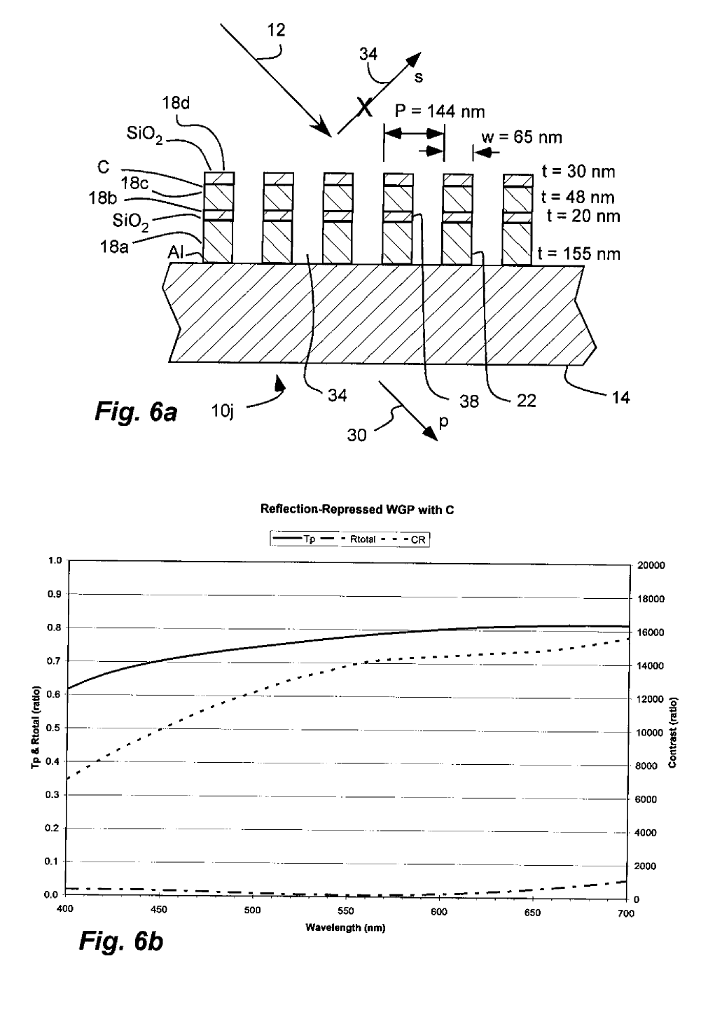

Referring to FIG. 6a, a fifth non-limiting example of a reflection repressed, wire-grid polarizer 10j is shown configured for use in the visible spectrum.

The polarizer 10j has four layers disposed over a substrate 14 including a polarizing layer 18a, a reflection-repressing layer 18c, a dielectric layer 18b separating the polarizing and reflection-repressing layers, and a second dielectric layer 18d separated from the first dielectric layer 18b by the reflection-repressing layer. The substrate is glass, such as BK7 glass. The first layer or polarizing layer 18a is disposed on the substrate. The polarizing layer 18a is an array of parallel metal wires 22 formed of aluminum (AL) with a period P of 144 nm. The polarizing layer 18a has a thickness of 1550 nm. The reflection-repressing layer 18c is formed of carbon (; n≈2.35, k≈0.8344 at 550 nm) and has a thickness of 48 nm. The first and second dielectric layers 18b and 18d are formed of silicon dioxide (SiO2) and have a thickness of 20 nm and 30 nm respectively. All of the layers are discontinuous to form form-birefringent layers. The period P is 144 nm with a duty cycle (DC) or ratio of rib width to period of 0.45, or the width is approximately 67 nm. The carbon material has been chosen because of its optical index and its optically absorptive properties for the incident light. The polarizer will transmit the p-polarization orientation of the light without reflecting either polarization orientation.

Referring to FIG. 6b, the calculated performance of the polarizer 10j is shown in the visible spectrum. It can be seen that the polarizer has high transmission (greater approximately 60% across the visible spectrum and as high as 80%) for p-polarization orientation of the light, with substantially no reflection. In addition, the polarizer has a contrast ratio greater than 8,000 across the visible spectrum.

Various aspects of wire-grid polarizers, optical trains and/or projection/display systems are shown in U.S. Pat. Nos. 5,986,730; 6,081,376; 6,122,103; 6,208,463; 6,243,199; 6,288,840; 6,348,995; 6,108,131; 6,452,724; 6,710,921; 6,234,634; 6,447,120; and 6,666,556, which are herein incorporated by reference.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A reflection repressed wire-grid polarizer device for polarizing incident visible or infrared light and selectively repressing a reflected polarization, the device comprising:
a) a substrate;
b) a polarizing wire-grid layer disposed over the substrate having an array of parallel metal wires with a period less than half the wavelength of the incident light;
c) a reflection-repressing layer disposed over the substrate including an inorganic and non-dielectric material which is optically absorptive of visible or infrared light; and
d) a dielectric layer disposed between the polarizing wire-grid layer and the absorptive layer and including an inorganic and dielectric material.

2. A device in accordance with claim 1, wherein the dielectric layer is a first dielectric layer; and further comprising:
a second dielectric layer disposed over the substrate and separated from the first dielectric layer by the reflection-repressing layer or polarizing wire-grid layer, and including an inorganic and dielectric material.

3. A device in accordance with claim 1, wherein the reflection-repressing layer is discontinuous to form an array of parallel ribs defining a reflection-repressing grid; and wherein the dielectric layer is discontinuous to form an array of parallel ribs defining a dielectric grid.

4. A device in accordance with claim 1, wherein the device selectively absorbs light within the visible spectrum; wherein the period of the array of wires of the wire-grid layer is less than 350 nm; and wherein the material of the reflection-repressing layer includes a material that is optically absorptive of light in the visible spectrum.

5. A device in accordance with claim 1, wherein the device selectively absorbs light within the infrared spectrum; wherein the period of the array of wires of the wire-grid layer is less than 500 nm; and wherein the material of the reflection-repressing layer includes a material that is optically absorptive of light in the infrared spectrum.

6. A device in accordance with claim 1, wherein the material of the reflection-repressing layer is different than a material of the metal wires of the wire-grid.

7. A device in accordance with claim 1, wherein the material of the reflection-repressing layer is selected from the group consisting of: carbon, silicon, niobium siliside, tantalum, and combinations thereof.

8. A reflection repressed wire-grid polarizer device for polarizing incident visible or infrared light and selectively repressing a reflected polarization, the device comprising:
a) a substrate;
b) a polarizing wire-grid disposed over the substrate having an array of parallel metal wires with a period less than half the wavelength of the incident light;
c) an inorganic and dielectric grid disposed over the polarizing wire-grid having an array of parallel ribs aligned with the wires of the polarizing wire-grid; and
d) a non-dielectric, reflection-repressing grid disposed over the inorganic and dielectric grid having an array of parallel ribs aligned with the ribs of the inorganic and dielectric grid and including an inorganic and non-dielectric material which is optically absorptive of visible or infrared light.

9. A device in accordance with claim 8, further comprising:
a second inorganic and dielectric layer disposed over the reflection-repressing layer.

10. A device in accordance with claim 8, wherein the material of the non-dielectric, reflection-repressing grid is different than a material of the metal wires of the wire-grid.

11. A device in accordance with claim 8, wherein the device selectively absorbs light within the visible spectrum; wherein the period of the array of wires of the wire-grid is less than 350 nm; and wherein the material of the reflection-repressing layer includes a material that is optically absorptive of light in the visible spectrum.

12. A device in accordance with claim 8, wherein the device selectively absorbs light within the infrared spectrum; wherein the period of the array of wires of the wire-grid layer is less than 500 nm; and wherein the material of the reflection-repressing grid includes a material that is optically absorptive of light in the infrared spectrum.

13. A device in accordance with claim 9, wherein the material of the reflection-repressing grid is selected from the group consisting of: carbon, silicon, niobium siliside, tantalum, and combinations thereof.

14. A reflection repressed wire-grid polarizer device for polarizing incident visible or infrared light and selectively repressing a reflected polarization, the device comprising:
a) a substrate;
b) a plurality of different, alternating layers carried by the substrate, the layers being discontinuous to form an array of parallel ribs with a period less than half the wavelength of the incident light;
c) one of the layers including a conductive material and defining a polarizing wire-grid;
d) one of the layers including an inorganic and dielectric material and defining a dielectric grid; and
e) one of the layers including an inorganic and non-dielectric material that is optically absorptive of visible or infrared light, and defining a reflection-repressing grid.

15. A device in accordance with claim 14, further comprising:
one of the layers defining a second dielectric grid including an inorganic and dielectric material.

16. A device in accordance with claim 14, wherein the device selectively absorbs light within the visible spectrum; wherein the period of the array of wires of the wire-grid is less than 350 nm; and wherein the material of the reflection-repressing layer includes a material that is optically absorptive of light in the visible spectrum.

17. A device in accordance with claim 14, wherein the device selectively absorbs light within the infrared spectrum; wherein the period of the array of wires of the wire-grid layer is less than 500 nm; and wherein the material of the reflection-repressing grid includes a material that is optically absorptive of light in the infrared spectrum.

18. A device in accordance with claim 14, wherein the material of the reflection-repressing grid is selected from the group consisting of: carbon, silicon, niobium siliside, tantalum, and combinations thereof.

19. A device in accordance with claim 14, wherein device has a contrast in transmission greater than about 500:1 across the visible spectrum.
